(19) United States
(12) Patent Application Publication
(10) Pub. No.: US 2011/0122140 A1
(43) Pub. Date: May 26, 2011

(54) DRAWING DEVICE AND DRAWING METHOD

(76) Inventor: Yoshiteru Kawasaki, Osaka (JP)

(21) Appl. No.: 13/054,801

(22) PCT Filed: May 12, 2010
(86) PCT No.: PCT/JP2010/003213

§ 371 Date: Jan. 19, 2011

(30) Foreign Application Priority Data
May 19, 2009 (JP) 2009-120582

(51) Int. Cl. G06T 11/20

(52) U.S. Cl. 345/441

(57) ABSTRACT

Provided is a drawing device which reduces an increase in computing amount when filtering is performed and does not require consideration of drawing order of a graphic object and a shadow shape. A drawing device (600) includes: a rasterization result storage unit (603) for storing original image data including pixel location information of an original image; a rasterizing unit (602) which generates original image data and writes the generated original image data into the rasterization result storage unit (603); a pixel-to-be-filtered determination unit (604) which reads the original image data and determines, for each pixel, whether or not filtering is to be performed, using the pixel location information; a filtering unit (606) which performs filtering based on the determination result of whether or not the filtering is to be performed and generates filtered data; and a drawing unit (607) which performs drawing by combining (i) original image data in pixels included in the original image out of the pixels that have been determined not to be filtered, and (ii) the filtered data in pixels that have been determined to be filtered.

### TECHNICAL FIELD

The present invention relates to various drawing techniques including drawing by digital consumer appliances via user interfaces, and in particular, to a drawing device and a drawing method which perform filtering on an image to be drawn.

### BACKGROUND ART

In recent years, lettering by appliances has had to have appealing design aesthetics and improved legibility. A “drop shadow” is a well known technique for significantly improving design aesthetics and legibility of lettering.

The drop shadow is an effect which draws a quasi-shadow behind a graphic object to give a user the impression that the graphic object is raised. For example, FIG. 1A and FIG. 1B are examples of an interface (IF) screen on television. In these examples, a menu is displayed being superimposed on video 105 displayed on the television screen so that the user can select a replay function and a recording function both of which are included in the television.

More particularly, FIG. 1A is a diagram showing an example of the IF screen display with a drop shadow effect according to a conventional technique. FIG. 1B is a diagram showing an example of the IF screen display without the drop shadow effect according to the conventional technique.

As shown in FIG. 1A, the menu for the replay function includes a character string 101 of [symbol] (which means replay), a shadow 102 of the character string 101, a plate-like rectangle 103 which surrounds the character string 101, and a shadow 104 of the plate-like rectangle 103. By using the drop shadow effect in this manner, it is possible to give the user a three-dimensional appearance as if the menu for the replay function is raised above the television image 105, compared to the case where the drop shadow effect is not used as shown in FIG. 1B. The same applies to the menu for the recording function.

At the same time, higher-resolution display screens are available along with the advent of higher performance appliances. In the field of drawing techniques, applications of vector graphics (VG) techniques are spreading which provide high-quality drawing results regardless of the display resolution.

Since Open VG had been developed which is a global standard application program interface (API) of vector graphics, various graphics processing units (GPUs) which provide hardware acceleration to the API defined by the Open VG have been introduced. It is expected that the number of drawing applications which use the Open VG rapidly increases in the future.

The Open VG also standardizes the API for implementing the drop shadow. Here, reference is made to the procedure for drawing a graphic object with a drop shadow effect using the API defined by the Open VG.

FIG. 2 is a flowchart of processing performed by a conventional drawing device 300 for implementing the drop shadow by using the Open VG. FIG. 3 is a block diagram showing a functional structure of the conventional drawing device 300 for implementing the drop shadow by using the Open VG. FIG. 4A to FIG. 4D show specific examples of input data, intermediate data, and output data in a case where a character string [symbol] (which means “replay”) is drawn with a drop shadow effect using the above procedure.

To begin with, as shown in FIG. 2, the user sets vector data (vertex data) of the graphic object to be drawn to the Open VG included in the drawing device 300 (S102). Here, the vector data is a series of two dimensional coordinates (x, y) of curve control points when the outline of the graphic object is represented by collections of straight lines or bezier curves. For example, in general, the vector data is widely available as True Type font data.

FIG. 4A shows an example of this case. More specifically, FIG. 4A is a diagram showing an example of input data for implementing the drop shadow. The processing is performed by a graphic vector data input unit 301 included in the drawing device 300 shown in FIG. 3. More particularly, the processing is performed by the API of vgAppendPathData( ) of the Open VG.

Description is continued with reference to FIG. 2. Next, the drawing device 300 fills in pixels in the interior region of the outline represented by the vector data to convert into image data (S104). More specifically, the drawing device 300 determines, for each of the pixels included in the image, whether or not the filling is to be performed, based on the relation between the pixel location and the outline location, and fills in the pixels which need to be filled in. Hereinafter, this processing is referred to as rasterizing.

FIG. 4B shows an example of a result obtained from the rasterizing. In other words, FIG. 4B is a diagram showing an example of intermediate data for implementing drop shadow. Further, the processing is performed by the rasterizing unit 302 included in the drawing device 300 shown in FIG. 3. More specifically, the processing is performed by the API of the vgDrawPath( ) of the OpenVG. Here, the rasterizing unit 302 stores the rasterization result in the rasterization result storage unit 303. At this point, the rasterization result is not yet displayed to the user.

The description is continued with reference to FIG. 2. Next, the drawing device 300 applies blur filter to the rasterization result stored in the rasterization result storage unit 303 so as to obtain quasi-shadow shape of the graphic object (S106). With this, it is possible to obtain an image with blurred rasterization result.

The filtering is processing which performs, for each pixel included in an image, a multiply-accumulate operation where pixel values of surrounding (M×N) pixels and (M×N) filter coefficients are multiplied and added. The processing is performed on all pixels, and provides images with effects such as blurring or accented edges.

FIG. 5A to 5C are diagrams showing details of the filtering processing according to a conventional technique. More particularly, FIG. 5A to FIG. 5C visually show the processing where pixel value p′(x,y) that is the filtering result of the pixel value p(x,y) at the coordinate location (x,y) is obtained, when filtering the graphic image indicated below.

[symbol]

More specifically, FIG. 5A is a diagram showing a range of (M×N) pixels that is to be filtered to obtain the pixel value p′(x,y) of the filtering result. The values of M and N that are the processing range vary depending on the filtering effect desired; however, here, an example of (7×7) pixels is shown. FIG. 5B is a mathematical formula for obtaining the pixel value p′(x,y) of the filtering result. FIG. 5C is a diagram visually showing the mathematical formula. The filtering coefficient indicated by k is arbitrarily set depending on the filtering effect desired.

As shown in these figures, in the filtering processing, it is necessary to multiply a filter coefficient to each of M×N pixels around a pixel, and add up the multiplied values; and thus, each pixel requires multiply-accumulate operation for (M×N) times. In addition, this processing needs to be performed on all of the pixels included in an image, which results in heavy computing load.

The filtering is performed by a filtering unit 304 included in the drawing device 300 shown in FIG. 3. More specifically, the processing is performed by the API of vgGaussianBlur( ) of the OpenVG.

The filtering unit 304 stores the filtered image thus obtained in the filtering result storage unit 305.

FIG. 4C shows an example of a filtering result stored in the filtering result storage unit 305. As shown in FIG. 4C, the filtering processing provides an image where the character string [symbol] is blurred. In other words, FIG. 4C is a diagram showing an example of intermediate data for implementing drop shadow.

Description is continued with reference to FIG. 2. Next, the drawing device 300 draws, in a drawing result storage region, the shadow shape stored in the filtering result storage unit 305 and the graphic object shape stored in the rasterization result storage unit 303 (S108, and S110).

Here, the drawing device 300 draws the shadow shape at a location displaced by a few pixels from the drawing location of the graphic object. Furthermore, the drawing device 300 draws the shadow shape before drawing the graphic object. Part of the shadow shape is overwritten with the graphic object that is drawn later. This guarantees the layering order of the shadow shape and the graphic object, and provides the quasi-3D appearance.

FIG. 4D shows the result image obtained by the drawing device 300 drawing the graphic object and the shadow shape. In other words, FIG. 4D is a diagram showing an example of output data for implementing drop shadow. The processing is performed by a drawing unit 306 included in the drawing device 300 shown in FIG. 3. More specifically, the processing is performed by the API of vgDrawImage( ) of the OpenVG. The drawing result thus obtained is stored in the drawing result storage unit 307, and is displayed to the user.

In such a manner, the conventional drawing device 300 can perform drawing with a drop shadow effect.

Non-Patent Literature 1 discloses such a conventional technique.

### Citation List

### Non Patent Literature

### NPL 1

OpenVG Specification Version 1.1, [online], Khronos Group, [searched on May 19, 2009], Internet <URL:http://www.khronos.org/openvg/>

### SUMMARY OF INVENTION

### Technical Problem

However, the following two problems exist in the conventional drawing device 300.

The first problem is that an enormous amount of computation is required to obtain a drawing result when implementing drop shadow using the OpenVG that is a conventional standard API specification.

This is because it is necessary to perform a multiply-accumulate operation for (M×N) times for each pixel in the filtering processing for obtaining the shadow shape. Therefore, appliances which do not have enough hard resources such as CPU operation capability or memory bandwidth, are not capable of handling enormous amount of computation for drop shadow. As a result, the drawing speed significantly decreases. Thus, responses to the user's operations are degraded, which results in user unfriendliness.

The second problem is that the conventional drawing device 300 cannot draw a graphic object before drawing a shadow shape, because the drawing order of the graphic object and the shadow shape is fixed. The reason is that if the graphic object is drawn first before the shadow shape is drawn, the shadow overwrites the graphic object, which causes the layering order of the graphic object and the shadow shape to be opposite.

As described, the conventional drawing device 300 has the problems that an enormous amount of computation is necessary in filtering processing, and the drawing must be performed in consideration with the drawing order of the shadow shape and the graphic object.

The present invention has been conceived to solve the conventional problems, and has an object to provide a drawing device and a drawing method which reduce an increase in computation amount when performing filtering, and which do not require the consideration of the drawing order of the graphic object and the shadow shape.

### Solution To Problem

In order to achieve the objects, the drawing device according to an aspect of the present invention is a drawing device which performs filtering on an original image to be drawn to decorate the original image. The drawing device includes: a first storage unit which stores original image data which indicates the original image and includes pixel location information indicating a location of a pixel included in the original image; a rasterizing unit which generates the original image data and to write the generated original image data into said first storage unit; a pixel-to-be-filtered determination unit which reads the original image data stored in said first storage unit and to determine, for each pixel, whether or not the filtering is to be performed, by using the pixel location information included in the read original image data; a filtering unit which (i) does not perform the filtering on one or more pixels that have been determined not to be filtered, and (ii) performs the filtering on one or more pixels that have been determined to be filtered so as to generate filtered data that is obtained from a result of the filtering; and a drawing unit which performs drawing by combining (i) original image data in a pixel included in the original image out of the one or more pixels that have been determined not to be filtered, and (ii) filtered data in the one or more pixels that have been determined to be filtered.

With this, it is determined for each pixel whether or not filtering is to be performed. Filtering is not performed on the pixels that have been determined not to be performed, and filtering is performed on the pixels that have been determined to be filtered. In other words, by knowing in advance portions to be filtered and portions not to be filtered and by not filtering the portions that have been determined that the filtering is not necessary, it is possible to reduce an increase in the computation amount for filtering. With this, even the drawing devices which have limited hard resources are capable of adding drop shadow effects rapidly.

In addition, the drawing is performed by combining the original image data in the pixels included in the original image among the pixels that have been determined not to be filtered and the filtered data in the pixels that have been determined to be filtered. More specifically, the pixels drawn by original image data (pixels included in the graphic object) are the pixels that have been determined not to be filtered, and the pixels drawn by the filtered data (pixels included in the shadow shape) are the pixels that have been determined to be filtered. Thus, the pixels included in the graphic object and the pixels included in the shadow shape are not the same. Therefore, such a case does not occur where the graphic object and the shadow shape overlap one another and the shadow shape overwrites the graphic object. Thus, it is not necessary to consider the drawing order of the graphic object and the shadow shape.

Further, it is preferable that said rasterizing unit calculates, as the pixel location information, coordinate location data indicating a coordinate location of a pixel included in the original image, so as to generate the original image data including the coordinate location data, and said pixel-to-be-filtered determination unit determines that the filtering is not to be performed on the pixel at the coordinate location indicated by the coordinate location data.

With this, it is determined that filtering is not to be performed on the pixels at the coordinate locations included in the original image (graphic object). In other words, filtering is performed on the exterior region of the graphic object, and the shadow shape is drawn. Thus, when filtering processing is performed where the shadow shape is drawn at the exterior region of the graphic object (exterior drop shadow), an increase in the computation amount can be reduced. Also, it is not necessary to consider the drawing order of the graphic object and the shadow shape.

Further, it may be that the rasterizing unit calculates, as the pixel location information, coordinate location data indicating a coordinate location of a pixel included in the original image so as to generate the original image data including the coordinate location data, and said pixel-to-be-filtered determination unit determines that the filtering is not to be performed on a pixel other than the pixel at the coordinate location indicated by the coordinate location data.

With this, it is determined that filtering is not to be performed on the pixels other than the pixels at the coordinate locations included in the original image (graphic object). In other words, filtering is performed on the interior region of the graphic object and the shadow shape is drawn at the interior region of the graphic object. Thus, when filtering processing is performed where the shadow shape is drawn in the interior region of the graphic object is drawn (interior drop shadow), an increase in the computation amount can be reduced. Also, it is not necessary to consider the drawing order of the graphic object and the shadow shape.

Further, it is preferable that the drawing device further includes a second storage unit which store, for each pixel, filtering-necessity-data indicating whether or not the filtering is to be performed, wherein said pixel-to-be-filtered determination unit updates the filtering-necessity data stored in said second storage unit by determining, for each pixel, whether the filtering is to be performed or not, and said filtering unit generates the filtered data with reference to the updated filtering-necessity-data.

With this, the second storage unit stores the filtering-necessity-data indicating whether or not filtering is to be performed, and filtered data is generated with reference to the filtering-necessity-data stored in the second storage unit. Thus, it is possible to generate filtered data by easily determining, by using the filtering-necessity-data indicating whether or not the filtering is to be performed.

Note that the present invention can be implemented not only as such a drawing device, but also as an integrated circuit including the respective processing units included in the device, and a method including the processing of the respective processing units as steps. In addition, the present invention can also be implemented as a program causing a computer to execute the steps, a recording medium such as a computer-readable CD-ROM which stores the program, and information, data or a signal indicating the program. The program, the information, the data, and the signal may also be distributed via a communications network such as the Internet.

### Advantageous Effects of Invention

The drawing device according to an aspect of the present invention is capable of reducing an increase in the computation amount when performing filtering. Furthermore, with the use of the drawing device according to an aspect of the present invention, it is not necessary to consider the drawing order of the graphic object and the shadow shape.

### BRIEF DESCRIPTION OF DRAWINGS

FIG. 1A is a diagram showing an example of an IF screen display where a conventional drop shadow is used.

FIG. 1B is a diagram showing an example of the IF screen display where the conventional drop shadow is not used.

FIG. 2 is a flowchart showing the processing of the drawing device for implementing the conventional drop shadow.

FIG. 3 is a block diagram showing a functional structure of the drawing device for implementing the conventional drop shadow.

FIG. 4A is a diagram showing an example of input data for implementing the conventional drop shadow.

FIG. 4B is a diagram showing an example of intermediate data for implementing the conventional drop shadow.

FIG. 4C is a diagram showing an example of intermediate data for implementing the conventional drop shadow.

FIG. 4D is a diagram showing an example of final data for implementing the conventional drop shadow.

FIG. 5A is a diagram showing the details of the filtering according to a conventional technique.

FIG. 5B is a diagram showing the details of the filtering according to the conventional technique.

FIG. 5C is a diagram showing the details of the filtering according to the conventional technique.

FIG. 6 is a block diagram showing a functional structure of a drawing device according to an embodiment of the present invention.

FIG. 7 is a diagram showing an example of original image data according to the embodiment of the present invention.

FIG. 8 is a diagram showing an example of filtering-necessity-data according to the embodiment of the present invention.

FIG. 9 is a flowchart of overall processing of the drawing device according to the embodiment of the present invention.

FIG. 10 is a flowchart of processing, performed by a pixel-to-be-filtered determination unit, for updating filtering-necessity-data.

FIG. 11A is a diagram where the filtering-necessity-data stored by the filtering-necessity-data storage unit are arranged based on the coordinate locations according to the embodiment of the present invention.

FIG. 11B is a diagram where the filtering-necessity-data stored by the filtering-necessity-data storage unit are arranged based on the coordinate locations according to the embodiment of the present invention.

FIG. 11C is a diagram where filtering-necessity-data stored by the filtering-necessity-data storage unit are arranged based on the coordinate locations according to the embodiment of the present invention.

FIG. 12 is a diagram showing a specific example of the filtering-necessity-data stored by the filtering-necessity-data storage unit according to the embodiment of the present invention.

FIG. 13 is a diagram showing the processing of a drawing device according to a variation of the embodiment of the present invention.

FIG. 14 is a diagram showing another example of processing performed by the drawing device according to the embodiment of the present invention.

FIG. 15 is a diagram showing an example where the drawing device according to the embodiment and the variation of the present invention is implemented as an integrated circuit.

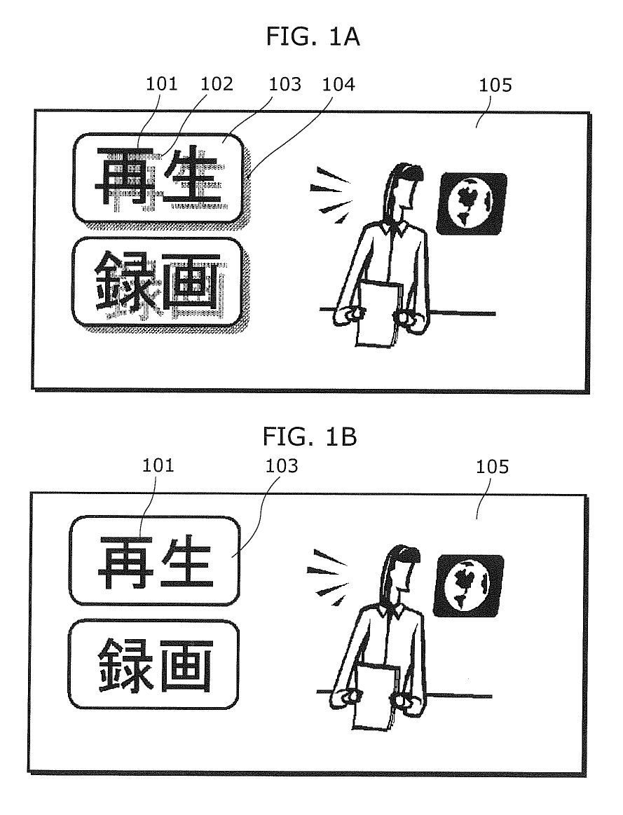

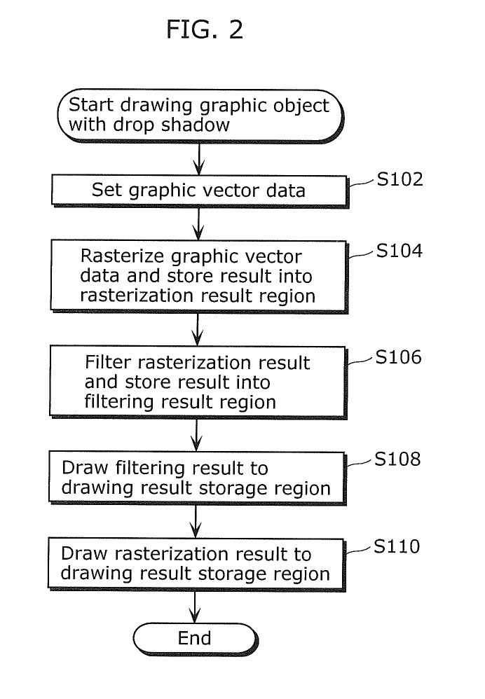

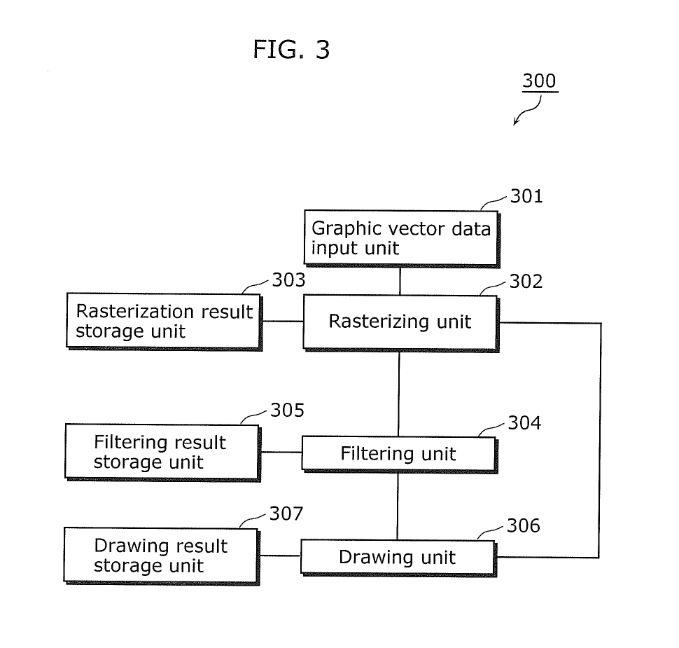

### DESCRIPTION OF EMBODIMENTS

Hereinafter, a drawing device according to an embodiment of the present invention is described with reference to the drawings.

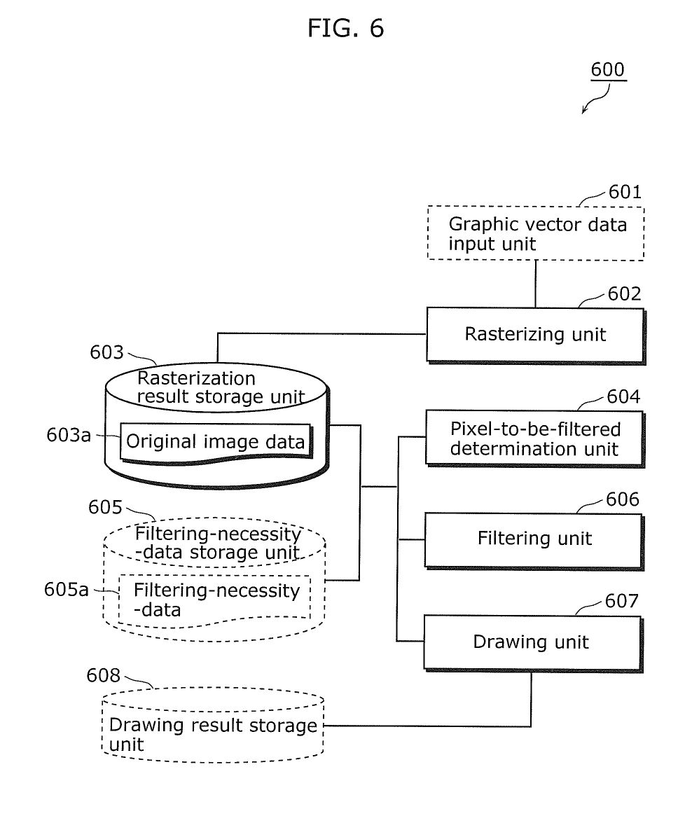

FIG. 6 is a block diagram showing a functional structure of a drawing device 600 according to the embodiment of the present invention.

The drawing device 600 is a device which performs, on an original image to be drawn, filtering for decorating the original image. As shown in FIG. 6, the drawing device 600 includes a graphic vector data input unit 601, a rasterizing unit 602, a rasterization result storage unit 603, a pixel-to-be-filtered determination unit 604, a filtering-necessity-data storage unit 605, a filtering unit 606, a drawing unit 607, and a drawing result storage unit 608.

The graphic vector data input unit 601 is a processing unit which reads vector data of an original image that is a graphic object to be drawn. Here, the vector data is pixel location information indicating locations of pixels included in an original image (coordinate location data indicating coordinate locations of pixels). The vector data is a series of control point coordinates when outline of the graphic object is represented by collections of straight lines or bezier curves. Examples of vector data include vector data that is widely available as True Type font data.

The rasterizing unit 602 is a processing unit which generates original image data 603a and writes the generated original image data 603a into the rasterization result storage unit 603. The original image data 603a is data indicating an original image, and is data that includes coordinate location data indicating the locations of the pixels included in the original image and color data indicating colors of the pixels included in the original image.

More particularly, the rasterizing unit 602 calculates, as the pixel location information, coordinate location data (vector data) indicating the coordinate locations of the pixels included in the original image, to generate the original image data 603a including the coordinate location data and the color data. In other words, the rasterizing unit 602 generates the original image data 603a in such a manner that the pixels in the interior region of the outline represented by the vector data are filled in with the color indicated by the color data.

Here, reference is made to the original image data 603a.

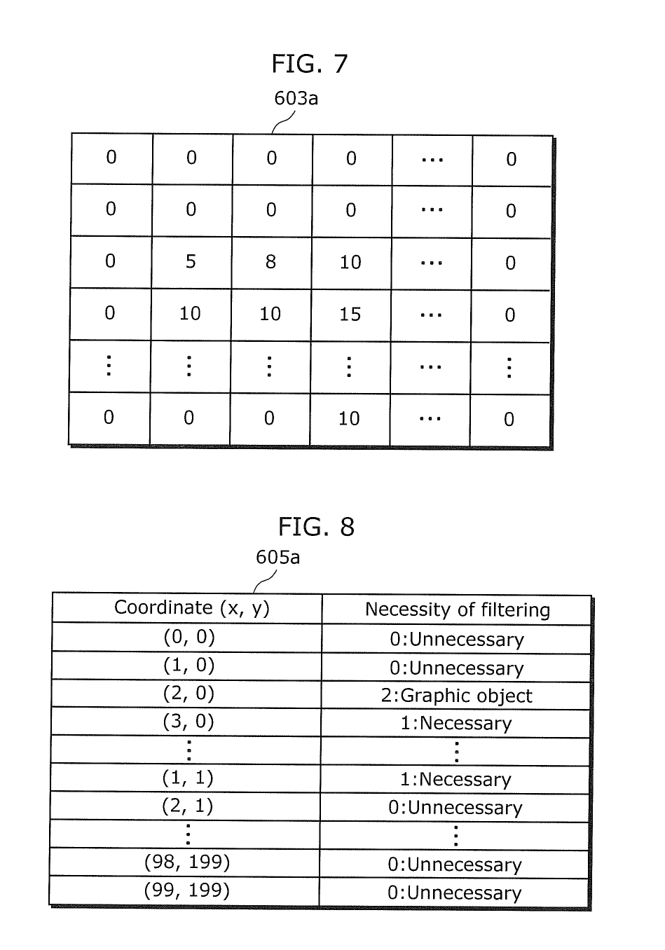

FIG. 7 is a diagram showing an example of the original image data 603a according to the present embodiment.

As shown in FIG. 7, the original image data 603a includes data indicating luminance value for each pixel according to the location of each pixel included in the original image. In the case where the original image is a color image, the location of each pixel in the original image data 603a also includes data indicating the color difference of each pixel. More specifically, the original image data 603a is a collection of pixel data including coordinate location data and color data of each pixel, and a series of combination of pixel location to be filled in and color used for the filling.

It is sufficient that the original image data 603a include the coordinate location data, and the color data do not always have to be included. In other words, the rasterizing unit 602 may generate the original image data 603a including only the coordinate location data.

Description is continued with reference to FIG. 6. The rasterization result storage unit 603 is a memory for storing the original image data 603a generated by the rasterizing unit 602. The rasterization result storage unit 603 corresponds to “the first storage unit” in Claims.

The pixel-to-be-filtered determination unit 604 is a processing unit which reads the original image data 603a stored in the rasterization result storage unit 603 and determines, for each pixel, whether or not filtering is to be performed, by using the pixel location information included in the read original image data 603a. More specifically, the pixel-to-be-filtered determination unit 604 determines, for each pixel which needs determination of the necessity of filtering, whether or not filtering is necessary based on the relation between the location of a pixel to be filled that is stored by the rasterization result storage unit 603 and a range to be filtered.

The pixels which need the determination of necessity of the filtering may be (i) the entire pixels displayed on a screen, (ii) pixels including the graphic object and a few pixels around the graphic object, or (iii) only the pixels included in the graphic object. The user may freely set the range of the pixels which need the determination of necessity of the filtering.

Here, in the present embodiment, the pixel-to-be-filtered determination unit 604 determines not to filter the pixels at the coordinate locations indicated by coordinate location data indicating the coordinate locations of pixels included in the original image.

The pixel-to-be-filtered determination unit 604 updates the filtering-necessity-data 605a stored in the filtering-necessity-data storage unit 605 by determining, for each pixel, whether or not filtering is to be performed.

The filtering-necessity-data storage unit 605a is a memory for storing the filtering-necessity-data 605a calculated by the pixel-to-be-filtered determination unit 604. The filtering-necessity-data 605a is data indicating, for each pixel, whether or not filtering is to be performed, and is a series of combination of pixel location and data indicating necessity of the filtering. The filtering-necessity-data storage unit 605 corresponds to the “second storage unit” in Claims.

Here, reference is made to the filtering-necessity-data 605a.

FIG. 8 is a diagram showing an example of filtering-necessity-data 605a according to the present embodiment.

As shown in FIG. 8, the filtering-necessity-data 605a is collection of information indicating “necessity of filtering” at the coordinate location “coordinate (x,y)” of each pixel. In other words, the “coordinate (x,y)” indicates the coordinate location of each pixel by the xy coordinate series, and the “necessity of filtering” indicates, for each pixel, whether or not filtering is to be performed.

For example, the pixel at the coordinate (0, 0) indicates that the filtering is not necessary, and the pixel at the coordinate (3, 0) indicates that the filtering is necessary. Furthermore, the pixel at the coordinate (2, 0) indicates that the pixel is included in the graphic object (original image).

Description is continued with reference to FIG. 6. The filtering unit 606 is a processing unit which, with reference to the updated filtering-necessity-data 605a, (i) does not perform filtering on the pixels that have been determined not to be filtered, and (ii) performs filtering on the pixels that have been determined to be filtered to generate filtered data obtained from the result of the filtering.

More particularly, the filtering unit 606 performs filtering only on the pixels that need to be filtered in the original image data 603a that is a rasterization result stored in the rasterization result storage unit 603, by using the filtering-necessity-data 605a that is information indicating whether or not filtering is necessary for each pixel and is stored in the filtering-necessity-data storage unit 605.

The drawing unit 607 performs drawing by combining original image data in the pixels included in the original image among the pixels that have been determined not to be filtered and filtered data in the pixels that have been determined to be filtered. In other words, the drawing unit 607 draws the original image data stored in the rasterization result storage unit 603 and the filtered data processed by the filtering unit 606.

The drawing result storage unit 608 stores data processed by the drawing unit 607.

In the following, reference is made to the operations of the drawing device 600 thus structured.

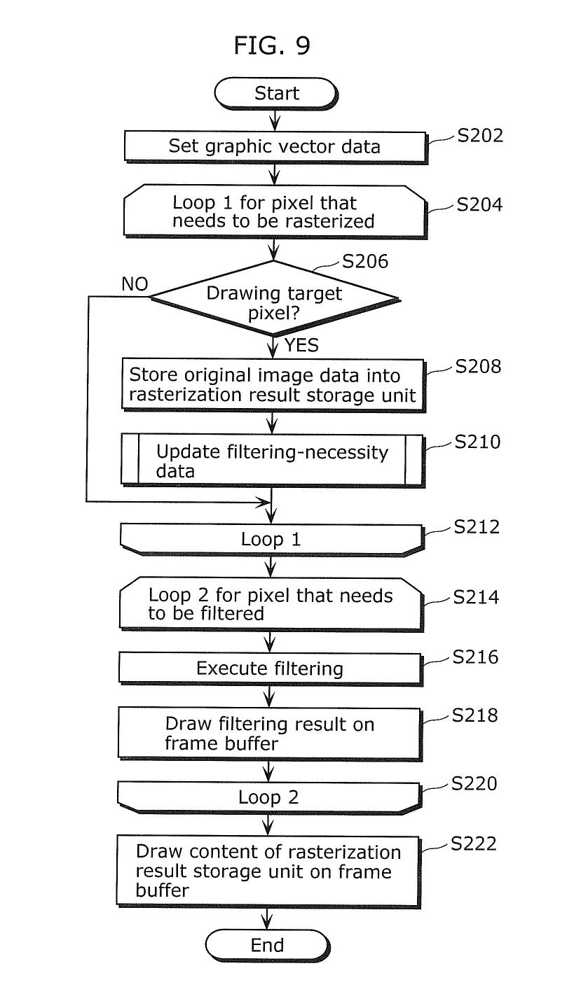

FIG. 9 is a flowchart showing an example of the operations of the drawing device 600 according to the present embodiment.

As shown in FIG. 9, at first, the graphic vector data input unit 601 reads vector data of an original image (S202). More specifically, the graphic vector data input unit 601 reads the vertex data sequence that has been set. Here, the graphic vector data input unit 601 can enlarge or reduce the size of the graphic object to be drawn, move the location of the drawing, and rotate the graphic object, by performing coordinate transformation on the read vertex data sequence as necessary.

Next, the rasterization is performed on the input vector data. Here, the following processing is performed on all the pixels that need to be rasterized (Loop 1: S204 to S212). The pixels that need to be rasterized may be pixels included in the range determined by the maximum value and the minimum value of the input vector data.

First, the rasterizing unit 602 determines whether or not a pixel is to be filled in or not (S206). The determination is performed for example, by a method where the rasterizing unit 602 determines if the is pixel is within the range surrounded by the vector data, and determines that the pixel is to be filled in if the pixel is within the range.

Here, in the case where the rasterizing unit 602 determines that the pixel is to be filled in (Yes in S206), the rasterizing unit 602 stores the data of the pixel in the original image data 603a, into the rasterization result storage unit 603 (S208). In such a manner, the rasterizing unit 602 generates the original image data 603a and writes the generated original image data 603a into the raterization result storage unit 603.

The pixel-to-be-filtered determination unit 604 reads, from the rasterization result storage unit 603, the original image data 603a including the location of pixel to be filled in, and calculates, based on the pixel location, the pixel range that needs to be filtered. Subsequently, the pixel-to-be-filtered determination unit 604 updates, using the result, the filtering-necessity-data 605a stored by the filtering-necessity-data storage unit 605 (S210).

Here, reference is made to the details of the update processing of the filtering-necessity-data 605a performed by the pixel-to-be-filtered determination unit 604.

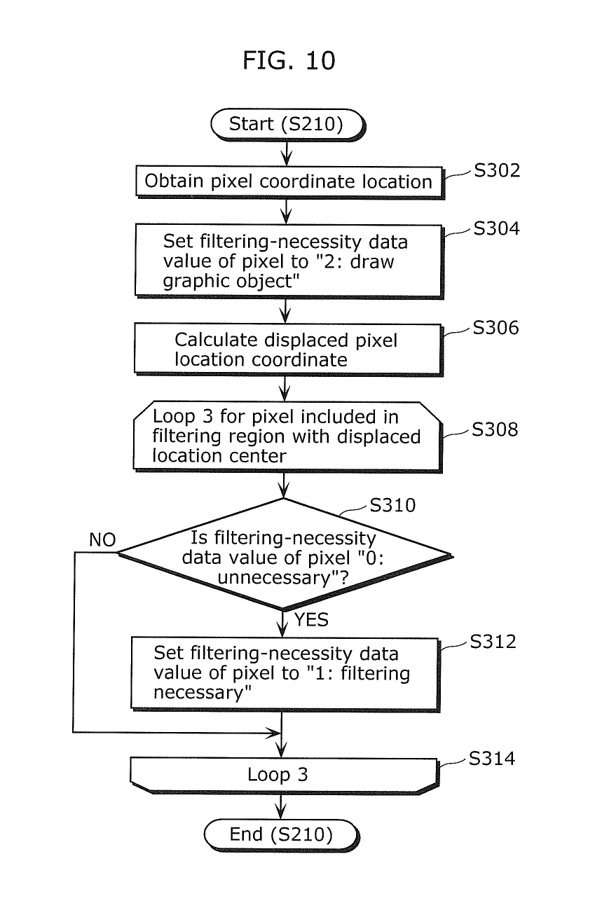

FIG. 10 is a flowchart of the processing performed by the pixel-to-be-filtered determination unit 604 for updating the filtering-necessity-data 605a according to the present embodiment.

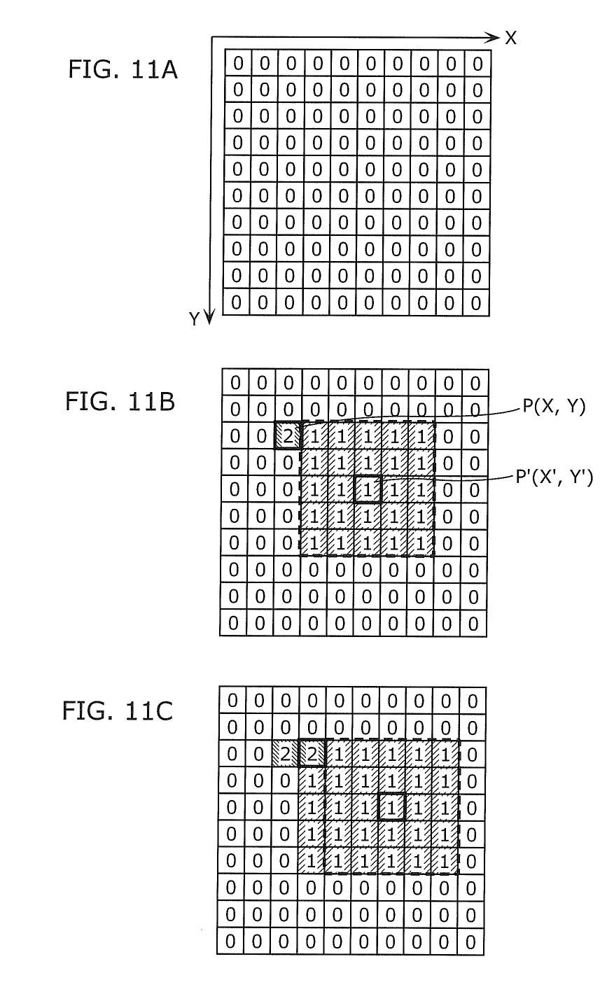

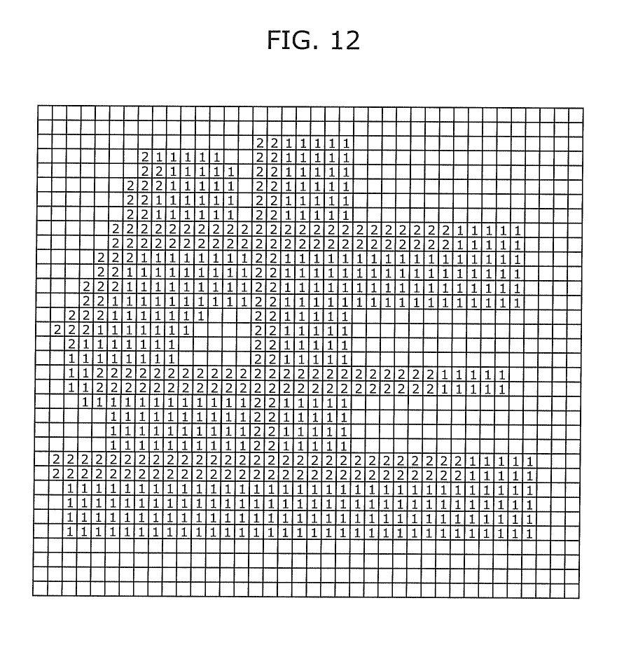

FIG. 11A to FIG. 11C each is a diagram where the filtering-necessity-data 605a are arranged based on the coordinate locations according to the present embodiment of the present invention. FIG. 12 is a diagram showing a specific example of the filtering-necessity-data 605a according to the present embodiment of the present invention. For ease of description, the filtering-necessity-data 605a are arranged in accordance with the pixel locations.

The filtering-necessity-data storage unit 605 holds three kinds of state values for all the pixels included in an image. The three kinds of state values are: “0: the pixel does not need to be filtered”, “1: the pixel needs to be filtered”, and “2: the pixel is for drawing graphic object”. FIG. 11A shows a specific example of the filtering-necessity-data 605a in an initial state. In the filtering-necessity-data 605a in its initial state, the state value of “0” is set to each pixel as an initial value.

As shown in FIG. 10, first, the pixel-to-be-filtered determination unit 604 reads the original image data 603a stored in the rasterization result storage unit 603 and receives the coordinate location data of pixels for filling in the graphic object in the rasterization processing (S302). The coordinate location data is two dimensional coordinate represented by a combination of P (X, Y). In the following description, an example case is described where the pixel-to-be-filtered determination unit 604 receives the coordinate of P (X=2, Y=2).

Next, the pixel-to-be-filtered determination unit 604 writes the value of “2: draw the graphic object” as the necessity of filtering of the coordinate P (X=2, Y=2) relative to the filtering-necessity-data 605a held by the filtering-necessity-data storage unit 605, in order to hold information that the pixel location P (X=2, Y=2) is a pixel for drawing the graphic object (S304). The pixels which have this value will be at the locations where the graphic object is drawn when displayed to the user at the end; and thus, the shadow shape does not need to be drawn for these pixels. In other words, it indicates that filtering is not necessary for the pixel at the location of the coordinate P (X=2, Y=2).

Next, the pixel-to-be-filtered determination unit 604 calculates coordinates displaced from the input coordinates with consideration of is the displacement amount of the shadow shape relative to the graphic object (S306). The displacement amount can be freely set by an input from the user.

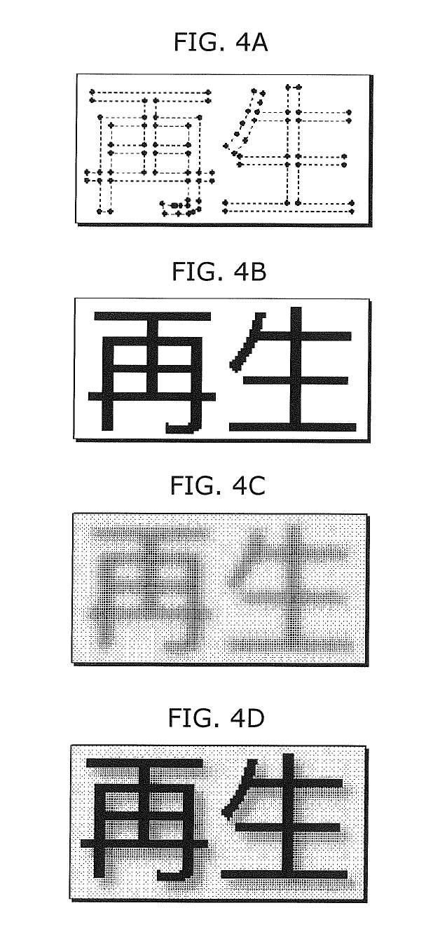

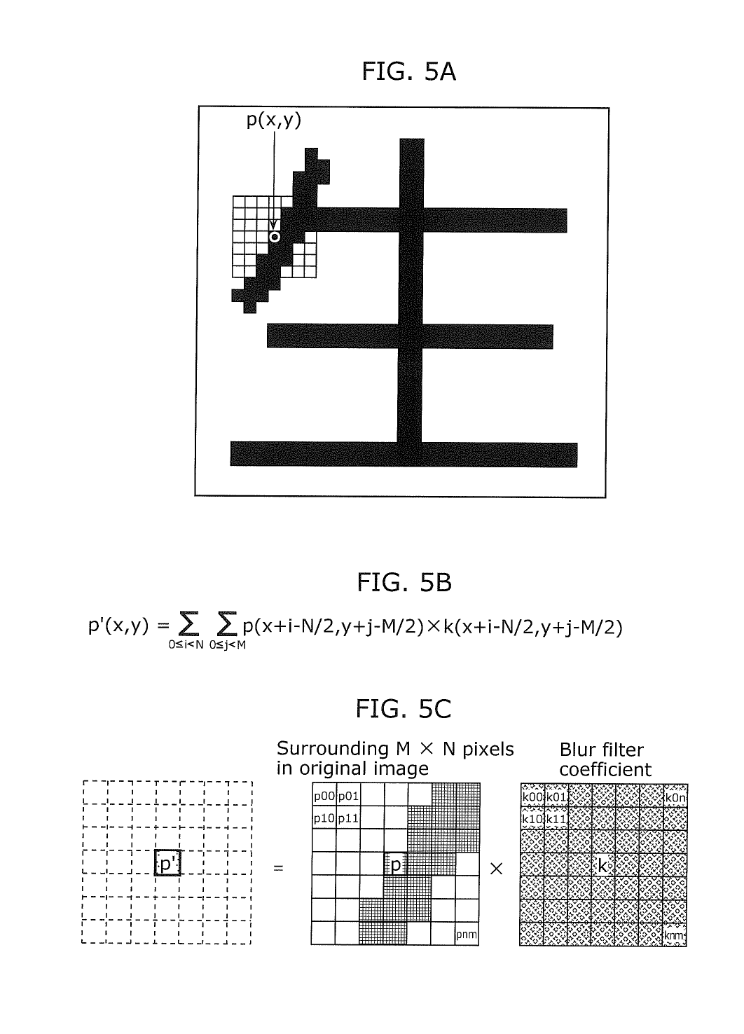

For example, in FIG. 4D, shadow shapes are drawn at locations displaced from the graphic objects by three pixels to the right and by two pixels to the bottom. In the case where the same amount of displacement is set, the pixel-to-be-filtered determination unit 604 calculates the location displaced from the input coordinate by three pixels to the right and by two pixels to the bottom. When the displaced location is P′ (X′, Y′), the displaced location coordinate is P′ (X′=5, Y′=4).

In this example, the displacement amount is set because the drop shadow is assumed as an effect to be added to the graphic object; however, in the case where other effects (e.g. shininess) are added, the displacement amount may be 0.

Next, the following processing is performed on the pixels included in the rectangular region of the filter size (M×N) that is the region to be filtered, with the displaced location coordinate P′ being center (Loop 3: S308 to 314). The value of the filter size (M×N) may be changed according to a desired filtering effect. Here, an example case is described where the filtering size is M=5, and N=5.

First, the pixel-to-be-filtered determination unit 604 sets the coordinate of one of the 5×5 pixels to the coordinate Q (X″, Y″), and reads the filtering-necessity-data of the coordinate Q. The pixel-to-be-filtered determination unit 604 determines whether or not the value of the read filtering-necessity-data is set to “0: filtering is not necessary” (S310). The coordinate Q is the coordinate of one of the 5×5 pixels. After the above processing, another pixel is selected from the 5×5 pixels to set to the coordinate Q. Subsequently, the above processing is performed on all of the pixels.

In the case where the pixel-to-be-filtered determination unit 604 determines that the value of the filtering-necessity-data for the coordinate Q is set to “0: filtering is not necessary” (Yes in S310), the pixel-to-be-filtered determination unit 604 writes the filtering-necessity-data of the coordinate Q to the value of “1: filtering is necessary” (S312).

In the case where the value of the filtering-necessity-data for the coordinate Q has already been set to “1: filtering is necessary” or to “2: drawing graphic object” (No in S310), the pixel-to-be-filtered determination unit 604 continues the processing on the next pixel without updating the filtering-necessity-data for the coordinate Q (Loop 3:S308 to 314).

In such a manner, the pixel-to-be-filtered determination unit 604 updates the filtering-necessity-data 605a as shown in FIG. 11B.

Description is continued with reference to FIG. 9. After updating the filtering-necessity-data for one pixel to be filled in the rasterization processing (S210), processing is returned to the rasterization processing loop again (Loop 1: S204 to 212) and the same processing is performed on the next pixel (S206 to 210).

For example, in the case where the pixel-to-be-filtered determination unit 604 determines that the location of the pixel to be filled in is at the coordinate of P (3, 2), the pixel-to-be-filtered determination unit 604 writes the value of “2: drawing graphic object” to the filtering-necessity-data 605a as the necessity of the filtering for the coordinate of P (X=3, Y=2) (S304 in FIG. 10).

The pixel-to-be-filtered determination unit 604 obtains P′ (X′=6, Y′=4) as the coordinate location displaced from the coordinate P (X=3, Y=2) by three pixels to the right and by two pixels to the bottom (S306 in FIG. 10).

The pixel-to-be-filtered determination unit 604 reads the filtering-necessity-data in the filtering-necessity-data storage unit 605 for the pixels included in the filter size with the displaced location coordinate P′ being center, and determines whether or not the data is set to “0: filtering is not necessary” (S310 in FIG. 10).

If it is determined that the data is set to “0: filtering is not necessary”, the pixel-to-be-filtered determination unit 604 writes the filtering-necessity-data of the filtering-necessity-data storage unit 605 as the value of the “1: filtering is necessary” (S312 in FIG. 10). In the case where the data has already been set to “1: filtering is necessary” or to “2: drawing graphic object”, the pixel-to-be-filtered determination unit 604 does not processing anything.

FIG. 11C shows the details of the filtering-necessity-data 605a of the filtering-necessity-data storage unit 605 thus far obtained. In the filtering-necessity-data 605a in FIG. 11B, the pixel of P (X=3, Y=2) is indicated as “1: filtering is necessary”; however, it is overwritten with “2: drawing graphic object” in FIG. 11C so that the region which does not need to be filtered can be identified.

Description is continued with reference to FIG. 9. The processing is returned to the rasterization processing loop again (Loop 1: S204 to 212) and the same processing (S206 to 210) is repeatedly performed on all the pixels that need to be rasterized.

With the processing (S204 to 212), the rasterization result corresponding to the input vector data is stored in the rasterization result storage unit 603, and the pixel region which needs to be filtered in the rasterization is stored in the filtering-necessity-data storage unit 605.

FIG. 12 shows an example of the filtering-necessity-data 605a at the time of completion of the determination of whether or not the filtering is necessary for the graphic object indicated below. [symbol] In FIG. 12, the pixels which have no value are the pixels to which “0: filtering is not necessary” is set. In the following processing, only the pixels which are set to “1: filtering is necessary” need to be filtered.

In FIG. 12, the graphic object is the character indicated below. [symbol] However, the graphic object is not limited to characters, and may be any graphics including pictures.

Description is continued with reference to FIG. 9. Next, the filtering unit 606 reads the filtering-necessity-data 605a stored by the filtering-necessity-data storage unit 605 so that the following processing (Loop 2: S214 to S220) is performed on the pixels that have the filtering necessity state “2: filtering is necessary”.

First, the filtering unit 606 performs filtering on the pixels that need to be filtered out of the original image data 603a stored in the rasterization result storage unit 603 (S216).

More specifically, the filtering unit 606 performs, on a single pixel which needs to be filtered, a multiply-accumulate operation where pixel values of surrounding (M×N) pixels and (M×N) filter coefficients are multiplied and added. The filtering unit 606 then generates filtered data that is the pixel value obtained from the result of the operation.

Next, the drawing unit 607 draws the pixel value (filtered data) obtained as the operation result of the filtering on a frame buffer (S218). The frame buffer refers to a data storage device included in the drawing result storage unit 608. The pixel values written to the frame buffer are displayed to the user as visual information via a display device such as a liquid crystal monitor.

In such a manner, the shadow shape is drawn on the frame buffer by performing the processing (S216 to S218) on all of the pixels that need to be filtered.

Lastly, the drawing unit 607 draws, on the frame buffer, the content of the original image data 603a stored in the rasterization result storage unit 603 (S222). In other words, the drawing unit 607 draws, on the frame buffer, the content of the original image data in the pixels included in the original image out of the pixels that have been determined not to be filtered.

With the processing above, the graphic object and the shadow shape are drawn on the frame buffer, so that a three-dimensional graphic can be drawn as shown in FIG. 4D, similarly to the conventional example.

With this, the drawing device 600 according to the present embodiment determines, for each pixel, whether or not filtering is to be performed. Filtering is not performed on the pixels which have been determined not to be performed, and the filtering is performed on the pixels that have been determined to be filtered. In other words, it is possible to reduce an increase in the computation amount in the filtering by previously knowing portions to be filtered and portions not to be filtered and by not filtering the portions that have been determined not to be filtered. With this, even the drawing devices, which have limited hard resources, are capable of adding drop shadow effects rapidly.

In addition, the drawing is performed by combining original image data in the pixels included in the original image out of the pixels that have been determined not to be filtered, and filtered data in the pixels that have been determined to be filtered. More specifically, the pixels drawn by the original image data (pixels included in the graphic object) are the pixels that have been determined not to be filtered, and the pixels drawn by the filtered data (pixels included in the shadow shape) are the pixels which have been determined to be filtered. Thus, the pixels included in the graphic object are always different from the pixels included in the shadow shape. Therefore, such a case does not occur where the graphic object and the shadow shape overlap one another and the shadow shape overwrites the graphic object. Thus, it is not necessary to consider the drawing order of the graphic object and the shadow shape.

Furthermore, it is determined that filtering is not to be performed on the pixels at the coordinate locations included in the original image (graphic object). In other words, filtering is performed on the exterior region of the graphic object so that the shadow shape is drawn. Thus, when filtering is performed where the shadow shape is drawn in the exterior region of the graphic object (exterior drop shadow), an increase in the computation amount can be reduced. Also, it is not necessary to consider the drawing order of the graphic object and the shadow shape.

The filtering-necessity-data 605a indicating whether the filtering is to be performed or not is stored in the filtering-necessity-data storage unit 605. The filtered data is generated by referring to the filtering-necessity-data 605a stored in the filtering-necessity-data storage unit 605. Thus, it is possible to generate filtered data by easily determining, by using the filtering-necessity-data 605a, whether or not the filtering is to be performed.

### Variation

In the embodiment, the pixel-to-be-filtered determination unit 604 determines not to filter the pixels at the coordinate locations included in the original image (graphic object). However, in the variation of the embodiment, the pixel-to-be-filtered determination unit 604 determines not to filter the pixels other than the pixels at the coordinate locations included in the original image (graphic object).

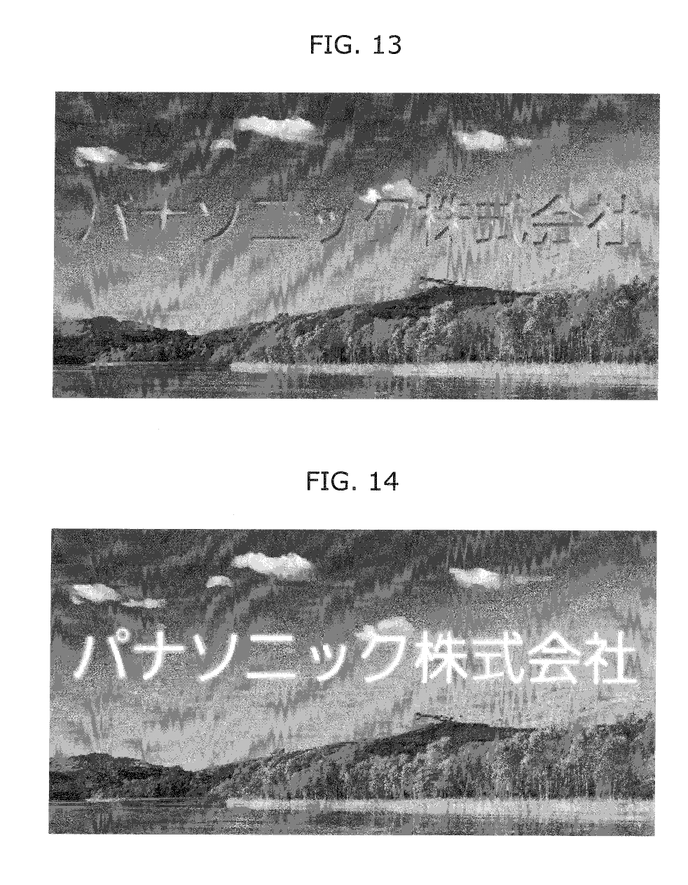

FIG. 13 is a diagram showing the processing performed by the drawing device 600 according to the variation of the embodiment.

The pixel-to-be-filtered determination unit 604 included in the drawing device 600 determines not to filter the pixels other than the pixels at the coordinate locations indicated by the coordinate location data of the pixels included in the original image. More specifically, the pixel-to-be-filtered determination unit 604 determines that the filtering is to be performed on the pixels at the coordinate locations indicated by the coordinate location data of the pixels included in the original image.

More specifically, in the processing performed by the pixel-to-be-filtered determination unit 604 for updating the filtering-necessity-data 605a shown in FIG. 9 (S210 in FIG. 9), the pixel-to-be-filtered determination unit 604 writes the filtering-necessity-data as the value of “0: filtering is not necessary” to the pixels other than the pixels included in the graphic object. The pixel-to-be-filtered determination unit 604 also writes the filtering-necessity-data as the value of “1: filtering is necessary” to the pixels included in the graphic object.

In this way, as shown in FIG. 9, the filtering is performed in the interior region of the graphic object, and the shadow shape (concaved shadow shape) is drawn in the interior region of the graphic object.

Thus, according to the drawing device 600 in the variation of the embodiment, it is possible to reduce an increase in the computation amount when filtering is performed where the shadow shape is drawn in the interior region of the graphic object (interior drop shadow). Also, it is not necessary to consider the drawing order of the graphic object and the shadow shape.

The drawing device 600 according to the present invention has been described based on the embodiment and the variation; however, the present invention is not limited to them.

It should be appreciated that the embodiment disclosed above is an example in all points, and is not intended to restrict the present invention. The scope of the present invention is specified by the claims, but not by the description made above, and further includes the meaning equivalent to the description of the claims and all changes within the scope thereof.

For example, in the embodiment, the drawing device 600 performs filtering to draw the shadow shape in the exterior region of the graphic object (exterior drop shadow). However, the drawing device 600 may perform filtering to give a shiny appearance (glow) on the edge of the graphic object. FIG. 14 is a diagram showing the processing performed by the drawing device 600 in this case. The filtering (glow) as shown in FIG. 14 can be performed by setting the displacement amount to 0 in the processing where the pixel-to-be-filtered determination unit 604 calculates a coordinate displaced from the graphic object (S306 in FIG. 10).

In the embodiment and the variation, the drawing device 600 includes: the graphic vector data input unit 601; the rasterizing unit 602; the rasterization result storage unit 603; the pixel-to-be-filtered determination unit 604; the filtering-necessity-data storage unit 605; the filtering unit 606; the drawing unit 607; and the drawing result storage unit 608. However, it may be that the drawing device 600 does not include the graphic vector data input unit 601, the filtering-necessity-data storage unit 605 and the drawing result storage unit 608 (the portions indicated by dashed lines in FIG. 6). In other words, it is sufficient that the drawing device 600 includes the rasterizing unit 602, the rasterization result storage unit 603, the pixel-to-be-filtered determination unit 604, the filtering unit 606, and the drawing unit 607. With such a structure, it is possible to achieve the objects of the present invention.

Note that the present invention can be implemented not only as the drawing device 600, but also as an integrated circuit including the respective processing units included in the device, and a method including the processing of the respecting processing units as steps. In addition, the present invention can also be implemented as a program causing a computer to execute the steps, a recording medium such as a computer readable CD-ROM which stores the program, and information, data or a signal indicating the program. The program, information, data, and signal may be distributed via a communications network such as the Internet.

For example, in the embodiment and the variation, part or all of the drawing device 600 may be mounted on a single integrated circuit, or may be implemented as plural integrated circuits mounted on a single circuit board.

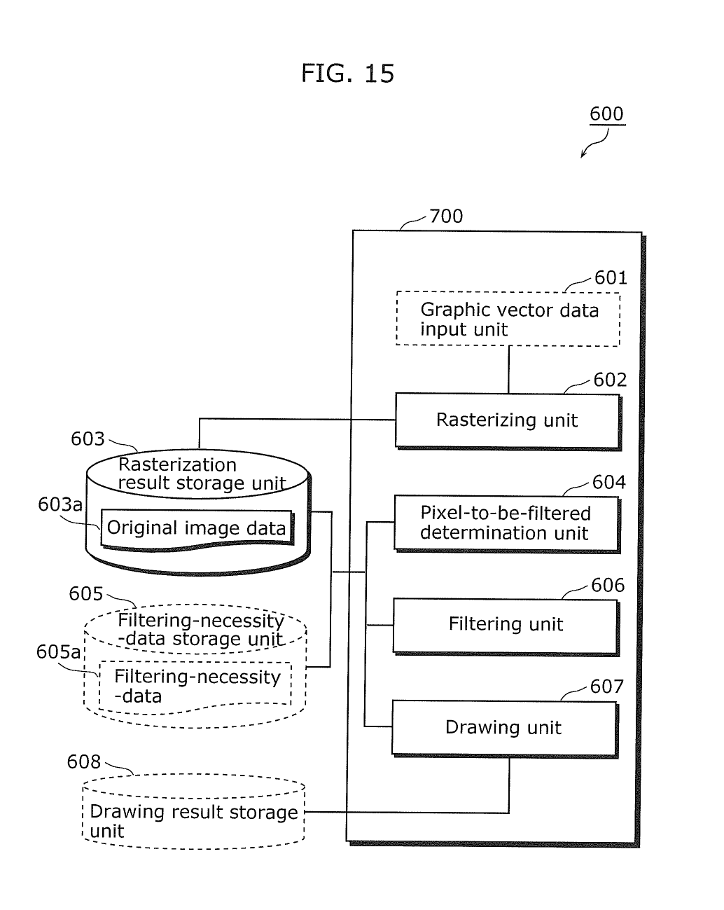

FIG. 15 is a diagram showing an example where the drawing device 600 according to the embodiment and the variation of the present invention is implemented as an integrated circuit 700.

As shown in FIG. 15, the integrated circuit 700 includes functions other than the rasterization result storage unit 603, the filtering-necessity-data storage unit 605 and the drawing result storage unit 608 that are included in the drawing device 600 shown in FIG. 6. Each processing units of the integrated circuit 700 may be made as separate individual chips, or as a single chip to include part or all of the processing units.

Furthermore, it may be that the integrated circuit 700 does not include the graphic vector data input unit 601 indicated by the dashed lines. In other words, it is sufficient that the integrated circuit 700 includes the rasterizing unit 602, the pixel-to-be-filtered determination unit 604, the filtering unit 606, and the drawing unit 607. With the structure, it is possible to achieve the objects of the present invention. Further, it may be that the integrated circuit 700 includes at least one of the rasterization result storage unit 603, the filtering-necessity-data storage unit 605, and the drawing result storage unit 608.

Here, the integrated circuit 700 is a Large Scale Integration (LSI); however, it may be referred to as an Integrated circuit (IC), a system LSI, a super LSI, an ultra LSI, depending on integration density.

Moreover, a technique of integrating into a circuit shall not be limited to the form of an LSI; instead, integration may be achieved in the form of a dedicated circuit or a general purpose processor. Employed as well may be the following: a Field Programmable Gate Array (FPGA) which is programmable after manufacturing of the LSI; or a reconfigurable processor which makes possible reconfiguring connections and configurations of circuit cells within the LSI.

In the case where a technique of making an integrated circuit replaces the LSI due to advancement in a semiconductor technology or another technique which derives therefrom, such a technique may be employed to integrate functional blocks as a matter of course. Applied as the technique can be biotechnologies.

### INDUSTRIAL APPLICABILITY

The drawing device according to the present invention is particularly useful for a device for drawing various types of characters and graphic objects, which is implemented as an interface display device for an embedded appliance which has a limited operation capability.

### REFERENCE SIGNS LIST

300 Drawing device
301 Graphic vector data input unit
302 Rasterizing unit
303 Rasterization result storage unit
304 Filtering unit
305 Filtering result storage unit
306 Drawing unit
307 Drawing result storage unit
600 Drawing device
601 Graphic vector data input unit
602 Rasterizing unit
603 Rasterization result storage unit
603a Original image data
604 Pixel-to-be-filtered determination unit
605 Filtering-necessity-data storage unit
605a Filtering-necessity-data
606 Filtering unit
607 Drawing unit
608 Drawing result storage unit
700 Integrated circuit

1. A drawing device which performs filtering on an original image to be drawn to decorate the original image, said drawing device comprising:
a first storage unit configured to store original image data which indicates the original image and includes pixel location information indicating a location of a pixel included in the original image;
a rasterizing unit configured to generate the original image data and to write the generated original image data into said first storage unit;
a pixel-to-be-filtered determination unit configured to read the original image data stored in said first storage unit and to determine, for each pixel, whether or not the filtering is to be performed, by using the pixel location information included in the read original image data;
a filtering unit configured (i) not to perform the filtering on one or more pixels that have been determined not to be filtered, and (ii) to perform the filtering on one or more pixels that have been determined to be filtered so as to generate filtered data that is obtained from a result of the filtering; and
a drawing unit configured to perform drawing by combining (i) original image data in a pixel included in the original image out of the one or more pixels that have been determined not to be filtered, and (ii) filtered data in the one or more pixels that have been determined to be filtered.

2. The drawing device according to claim 1,
wherein said rasterizing unit is configured to calculate, as the pixel location information, coordinate location data indicating a coordinate location of a pixel included in the original image, so as to generate the original image data including the coordinate location data, and
said pixel-to-be-filtered determination unit is configured to determine that the filtering is not to be performed on the pixel at the coordinate location indicated by the coordinate location data.

3. The drawing device according to claim 1,
wherein said rasterizing unit is configured to calculate, as the pixel location information, coordinate location data indicating a coordinate location of a pixel included in the original image so as to generate the original image data including the coordinate location data, and
said pixel-to-be-filtered determination unit is configured to determine that the filtering is not to be performed on a pixel other than the pixel at the coordinate location indicated by the coordinate location data.

4. The drawing device according to claim 1, further comprising
a second storage unit configured to store, for each pixel, filtering-necessity-data indicating whether or not the filtering is to be performed,
wherein said pixel-to-be-filtered determination unit is configured to update the filtering-necessity data stored in said second storage unit by determining, for each pixel, whether the filtering is to be performed or not, and
said filtering unit is configured to generate the filtered data with reference to the updated filtering-necessity-data.

5. A drawing method which performs filtering on an original image to be drawn to decorate the original image, said drawing method comprising:
generating original image data and writing the generated original image data into a first storage unit, the original image data indicating the original image and including pixel location information indicating a location of a pixel included in the original image;
reading the original image data stored in the first storage unit and determining, for each pixel, whether or not the filtering is to be performed, by using the pixel location information included in the read original image data;
not performing the filtering on one or more pixels that have been determined not to be filtered, and performing the filtering on one or more pixels that have been determined to be filtered so as to generate filtered data that is obtained from a result of the filtering; and
performing drawing by combining (i) original image data in a pixel included in the original image out of the one or more pixels that have been determined not to be filtered, and (ii) filtered data in the one or more pixels that have been determined to be filtered.

6. A program for performing filtering on an original image to be drawn to decorate the original image, said program being recorded on a non-transitory computer-readable recording medium, said program causing a computer to execute:
generating original image data and writing the generated original image data into a first storage unit, the original image data indicating the original image and including pixel location information indicating a location of a pixel included in the original image;
reading the original image data stored in the first storage unit and determining, for each pixel, whether or not the filtering is to be performed, by using the pixel location information included in the read original image data;
not performing the filtering on one or more pixels that have been determined not to be filtered, and performing the filtering on one or more pixels that have been determined to be filtered so as to generate filtered data that is obtained from a result of the filtering; and
performing drawing by combining (i) original image data in a pixel included in the original image out of the one or more pixels that have been determined not to be filtered, and (ii) filtered data in the one or more pixels that have been determined to be filtered.

7. A non-transitory computer-readable recording medium for use in a computer, the recording medium having a program recorded thereon, the program for performing filtering on an original image to be drawn to decorate the original image, the program causing the computer to execute:
generating original image data and writing the generated original image data into a first storage unit, the original image data indicating the original image and including pixel location information indicating a location of a pixel included in the original image;
reading the original image data stored in the first storage unit and determining, for each pixel, whether or not the filtering is to be performed, by using the pixel location information included in the read original image data;
not performing the filtering on one or more pixels that have been determined not to be filtered, and performing the filtering on one or more pixels that have been determined to be filtered so as to generate filtered data that is obtained from a result of the filtering; and
performing drawing by combining (i) original image data in a pixel included in the original image out of the one or more pixels that have been determined not to be filtered, and (ii) filtered data in the one or more pixels that have been determined to be filtered.

8. An integrated circuit which controls a drawing device which performs filtering on an original image to be drawn to decorate the original image, said integrated circuit comprising:
a rasterizing unit configured to generate original image data and write the generated original image data into a first storage unit, the original image data indicating the original image and including pixel location information indicating a location of a pixel included in the original image;
a pixel-to-be-filtered determination unit configured to read the original image data stored in said first storage unit and to determine, for each pixel, whether or not the filtering is to be performed, by using the pixel location information included in the read original image data;
a filtering unit configured (i) not to perform the filtering on one or more pixels that have been determined not to be filtered, and (ii) to perform the filtering on one or more pixels that have been determined to be filtered so as to generate filtered data that is obtained from a result of the filtering; and
a drawing unit configured to perform drawing by combining (i) original image data in a pixel included in the original image out of the one or more pixels that have been determined not to be filtered, and (ii) filtered data in the one or more pixels that have been determined to be filtered.
